(19) United States
(12) Patent Application Publication
(10) Pub. No.: US 2026/0337737 A1
(43) Pub. Date: Oct. 29, 2026

(54) Method for Producing a CoFe Alloy for a Laminated Core

(71) Applicant: VACUUMSCHMELZE GMBH & CO KG, Hanau (DE)

(72) Inventors: Johannes TENBRINK, Hanau (DE); Niklas VOLBERS, Hanau (DE); Jan Frederik FOHR, Hanau (DE); Maximilian STAAB, Hanau (DE)

(21) Appl. No.: 19/117,930

(22) PCT Filed: Oct. 2, 2023
(86) PCT No.: PCT/EP2023/077264

§ 371 Date: Apr. 2, 2025

(30) Foreign Application Priority Data
Oct. 4, 2022 (DE) 10 2022 125 560.3

(51) Int. Cl. C22C 38/10; C21D 6/00; C21D 9/00; C22C 38/12; H01F 1/147; H01F 41/02

(52) U.S. Cl. CPC C22C 38/10; C21D 6/007; C21D 9/0068; C22C 38/12; H01F 1/147; H01F 41/0206; C22C 2202/02

(57) ABSTRACT

A method for producing a CoFe alloy for a laminated core with a stack having laminations made of a CoFe alloy containing 5 to 55 wt. % Co is heat treated during final annealing in a background magnetic field for a dwell time t1 at a temperature T1, where T1 is between 700 °C and 960 °C, preferably 720 °C. to 950 °C, preferably 760 °C to 920 °C. The stack is then cooled to a temperature of less than 300 °C, preferably less than 200 °C. The stack is then heat treated for at least part of magnetic field annealing in an externally applied magnetic field for a dwell time t2 at a temperature T2, where T2 is between 500 °C and T1, preferably between 650 °C and T1, preferably between 700 °C and T1, and subsequently cooled to a temperature of less than 300 °C, preferably less than 200 °C. The externally applied magnetic field is greater than the background magnetic field.

### CROSS-REFERENCE TO RELATED APPLICATION(S)

This is a National Stage Entry into the United States Patent and Trademark Office from International Patent Application No. PCT/EP2023/077264, filed on Oct. 2, 2023, which relies on and claims priority to German Patent Application No. 10 2022 125 560.3, filed on Oct. 4, 2022, the entire contents of all of which are incorporated herein by reference.

### FIELD OF THE INVENTION

The invention relates to a method for producing a CoFe alloy for a laminated core.

### BACKGROUND OF THE INVENTION

Electric machines may be operated as motors or generator and in most designs comprise a stator made of a soft magnetic material. In operation, the direction and strength of the magnetic flux in the rotors and stators of electric machines change periodically. This alternating magnetic field induces eddy currents in a circular direction, i.e. in the direction of the longitudinal axes of rotor and stator. These eddy currents dissipate part of the energy supplied to the system as heat so that it ceases to contribute to the performance of mechanical work. A high electrical resistance of rotor and stator in the axial direction (the direction of the longitudinal axes of rotor and stator) is desirable in order to minimise these eddy currents and the losses associated with them. This is typically achieved by means of a layered structure.

The rotor and/or the stator of an electric machine may comprise a plurality of identical individual sheets (also referred to as “laminations” or “layers”) that are stacked one on top of another and at the same time electrically insulated from one another. A structure of this type is referred to as a laminated core (or “stack”). In such stacks eddy current losses are proportional to the square of the lamination thickness of the individual layers. Consequently, the thinner the layers, the lower the eddy current losses and the higher the efficiency.

It is desirable for the stator and the rotor to have a high power density so that the installed size of the electric machine is small and its performance high. The fill factor of a laminated core describes that proportion of magnetically conductive material within the laminated core. It is calculated by deducting the volume of insulating layers, adhesive layers, air gaps and other poorly magnetically conductive layers from the total volume. The power and torque densities, amongst other characteristics, that can be achieved with the drive unit depends on the fill factor. A high fill factor is therefore desirable.

In addition, a high magnetic conductivity (permeability) of the material and the capacity to carry the greatest possible flux density (induction) are advantageous in order to increase the performance of the stator. In applications in which the highest possible power density is necessary or desired, cobalt-iron (CoFe) alloys are used. Commercially available CoFe alloys typically have a composition of 49 wt. % Fe, 49 wt. % Co and 2 wt. % V.

### SUMMARY OF THE INVENTION

An object is therefore to provide a method with which it is possible to produce a laminated core having a high power density.

According to the invention, a method for producing a CoFe alloy for a laminated core is provided in a first embodiment. A stack comprising a plurality of laminations made of a CoFe alloy containing 5 to 55 wt. % Co is provided. The stack is heat treated for a dwell time t1 at a temperature T1, where T1 is between 700 °C and 960 °C, preferably 720 °C to 950 °C, preferably 760 °C to 920 °C, in a background magnetic field during final annealing. The stack is then cooled to a temperature of less than 300 °C, preferably less than 200 °C. The stack is then heat treated in a magnetic field annealing for a dwell time t2 at a temperature T2, where T2 is between 500 °C and T1, preferably between 650 °C and T1, preferably between 700 °C and T1, in an externally applied magnetic field for at least part of the magnetic field annealing, and then cooled to a temperature of less than 300 °C, preferably less than 200 °C. The externally applied magnetic field is greater than the background magnetic field.

Even if no specific magnetic field is applied, a background magnetic field is present since the earth itself generates a magnetic field with a field strength of approximately 0.05 mT. In addition, interfering magnetic fields generated by the electrically conductive heating elements of a furnace, for example, may also be present. At the same time, a metal hood that covers the stack may serve as a shield. This results in a background magnetic field with a value formed of this and other factors. The background magnetic field is no more than 1 kA/m, preferably less than 0.5 kA/m, preferably less than 0.1 kA/m.

During magnetic field annealing a further magnetic field in addition to the background magnetic field is actively applied such that the total magnetic field during magnetic field annealing is greater than the background magnetic field inherently present during final annealing. The actively applied external magnetic field is therefore greater than 0.1 kA/m. In some embodiments, the external magnetic field is set so as to produce a field strength of greater than 0.5 A/cm, preferably greater than 1 A/cm, particularly preferably greater than 3 A/cm in the soft magnetic material to be annealed.

Laminations or a laminated core made of a CoFe alloy with improved soft magnetic properties is provided by means of the heat treatment at high temperatures in an externally applied magnetic field.

The laminations each have a first main surface and second main surface opposite the first main surface. The first main surface of a first lamination may be stacked on the second main surface of a second lamination in a direction of stacking that is perpendicular to the first main surface in order to form a stack. In some embodiments, the laminations are loose in the stack. After magnetic field annealing the laminations are processed to form a laminated core. In other embodiments the laminations of the stack are fastened to one another by one or more weld seams or spots, for example, and form a laminated core. The laminated core is subjected to final annealing and then to a separate magnetic field annealing.

The CoFe alloy contains between 5 and 55 wt. % Co. The CoFe alloy may be a 50% CoFe alloy with a basic composition of approx. 49 wt. % Co, approx. 49 wt. % Fe and approx. 2 wt. % V. Well known trade names include VACOFLUX 48, VACOFLUX 50, VACODUR 50, VACODUR 49, VACODUR S Plus, HIPERCO 50, HIPERCO 50A, HIPERCO 50HS AFK 502 and AFK 502R. In addition to the main alloy elements of Co, Fe and V, some of these commercially available alloys also include grain-refining additives such as Nb, Ta and Zr, for example, which limit grain growth and so permit higher strengths.

CoFe alloys are subjected to so-called final annealing in order to improve their soft magnetic properties. The invention is based on the realisation that in such CoFe alloys these soft magnetic properties are largely isotropic in the lamination plane, and that the soft magnetic properties could be improved still further for use in electric machines if it were possible to produce a magnetically preferred direction.

The laminations of the stack or the laminated core may have a full section of a stator or part of a stator such as a stator ring or individual teeth. The stack or laminated core may take the form of a stator or of a segment of a stator such as a lateral part, i.e. components that are stacked on top of one another to form a part of a stator such as a stator ring or individual teeth (so-called T-tooth) or of a stator ring with individual teeth inserted into the stator ring.

It would be desirable for the manufacture of laminated cores for the individual parts to have improved soft magnetic properties such as increased permeability, for example, in the direction of their magnetic stress. In the case of individual teeth this would be the radial direction, i.e. the longitudinal axis of the tooth facing the centre of the laminated core in operation. In the case of a stator ring it would be the circumferential direction of the ring.

The individual segments or a motor or generator laminated core should therefore ideally be produced in such a manner as to produce improved properties such as increased permeability and thus reduced magnetic resistance, for example, in the direction of their primary magnetic stress. This would produce improved properties in comparison to an isotropic lamination.

According to the invention, these anisotropic soft magnetic properties are achieved by means of appropriate magnetic field annealing, it being possible to produce these improved magnetic properties in the desired direction.

In some embodiments, after magnetic field annealing the CoFe alloy has a remanence ratio Br/Bs greater than or equal to 0.8 with a remanence Br and a magnetic saturation Bs measured at 160 A/cm, and/or a maximum permeability μₘₐₓ of over 20,000, preferably over 30,000, particularly preferably over 40,000.

Magnetic field annealing can be carried out using two different technical processes. If the magnetic field is parallel to the subsequent direction of the flux density in the component it is referred to as a longitudinal magnetic field. In so-called longitudinal field annealing the magnetic field can be specified by electroconductive cables in the annealing furnace. A process whereby an external uniaxial field is applied by means of coil systems in a magnetic field furnace and this external uniaxial field is parallel to the subsequent direction of flux density in the component of the parts annealed in the furnace can also be referred to as longitudinal field annealing.

Longitudinal field annealing differs from so-called transverse field annealing, in which toroidal cores, for example, are threaded onto a rod and the magnetic field runs in the axial core direction or perpendicular to the strip direction of the toroidal cores. This arrangement may be used to produce toroidal cores with a flat, linear “F” loop.

Where a complete stator in the form of a stack of loose laminations or a laminated core is annealed, the desired preferred direction may be generated by appropriate annealing in a longitudinal magnetic field, i.e. the outer field is generated by the energisation of electrical conductors that run perpendicular to the lamination plane and that generate a magnetic field parallel to the subsequent magnetic direction of the parts, i.e. the main surface of the lamination.

Where stator segments are annealed individually, on the other hand, an external magnetic field with a source arranged outside the chamber of the furnace may be used. For example, the source may be a coil system that is arranged in the wall or outside the wall of a furnace. The magnetic field source and/or the segment or segments are oriented such that the circumferential direction of the stator segments is arranged so as to be as parallel as possible to the course of the magnetic field applied. In this case, there is no ideally tempered preferred direction since it is unable to run approximately parallel to the circumferential direction. It is, however, possible to achieve some improvement in properties compared to an isotropic lamination.

Where stator segments are annealed individually, the stator segments may be assembled to form a stator ring before annealing and the completely assembled stator ring may then be subjected to annealing in a longitudinal field in order to achieve the desired preferred direction around the circumference.

Where the stator ring and the individual teeth of a stator are manufactured separately, longitudinal field annealing during which the necessary longitudinal magnetic field is generated by electroconductive conductors may be used for the stator ring. In this case, the individual teeth may be annealed in an external magnetic field.

During the magnetic field annealing of stator segments in an external magnetic field one or more flux-conducting parts may be used. The flux-conducting part or parts are arranged such that in the subsequent motor application the flux created in the stator segment by the flux-conducting parts corresponds largely to the flux direction in the stator comprising the individual segments.

During magnetic field annealing the external magnetic field may be applied only partially or for a period of time or for the entire duration of the heat treatment.

In a first method, magnetic field annealing is carried out in a separate process after normal final annealing, which serves to set the structure during the cooling phase. For example, final annealing may be carried out in a conventional furnace without a magnetic field source and the stack may then be transported to another furnace equipped with a magnetic field source.

Final annealing is typically carried out at temperatures T1 of over 700 °C or greater than 720 °C, preferably between 750 °C and 960 °C. The maximum possible final annealing temperature is limited by the temperature at which the α/α+γ phase transition takes place. Good soft magnetic properties can only be set by annealing in the ferritic α-region. The temperature T1 may therefore be between 700 °C and T_{α/α+γ}. The temperature at which the α/α+γ phase transition takes place is dependent on the composition of the CoFe alloy. The dwell time t1 of final annealing may, for example, be between 0.5 and 10 hours. The cooling rate of cooling from T1 may be between 10 K/h and 1000 K/h, preferably between 30 K/h and 300 K/h. The maximum temperature used during magnetic field annealing is below the final annealing temperature.

In some embodiments, the external magnetic field is only applied during the cooling phase of magnetic field annealing to a temperature of less than 300 °C, preferably of less than 200 °C. As a result, the external magnetic field is applied neither during the heating phase nor during the dwell time t2 of magnetic field annealing.

In some embodiments, the external magnetic field is applied during dwell time t2 and during subsequent cooling to a temperature of less than 300 °C, preferably less than 200 °C. The magnetic field may be applied for the entire dwell time t2 and for the entire cooling phase from T2 to a temperature of less than 300 °C, preferably less than 200 °C.

In some embodiments, the external magnetic field is applied for less than 50% of dwell time t2 and for the whole of the subsequent cooling phase to a temperature of less than 300 °C, preferably less than 200 °C.

In some embodiments, the magnetic field is not applied until the second half of the dwell time t2 and then for the whole of the subsequent cooling phase to a temperature of less than 300 °C, preferably less than 200 °C.

The dwell time t2 of magnetic field annealing may be between 1 minute and 10 hours. The cooling rate of the cooling from T2 may be between 10 K/h and 1000 K/h, preferably between 30 K/h and 300 K/h.

Final annealing and magnetic field annealing may be carried out separately. For example, In some embodiments, final annealing and magnetic field annealing are carried out in different furnaces.

Final annealing may be carried out in an inert gas atmosphere, or a reducing atmosphere and/or magnetic field annealing can be carried out in a vacuum or in an inert gas atmosphere. In a two-stage method with separate final and magnetic field annealing, the atmosphere may be different during final annealing and magnetic field annealing. Pure nitrogen or argon may be used as the inert gas atmosphere. A hydrogen-containing atmosphere may be used as a reducing atmosphere. The hydrogen-containing atmosphere may be pure hydrogen or nitrogen and/or argon with an admixture of hydrogen. In one embodiment, the inert gas atmosphere or reducing atmosphere is dry. In some embodiments, the hydrogen-containing atmosphere has an starting dew point of less than −40 °C.

In an alternative method, magnetic field annealing is integrated into final annealing such that the stack is not first heated from T1 to a temperature of less than 300 °C and then subsequently reheated to a temperature T2. In particular, the external magnetic field is applied for at least part of the cooling of the stack from the final annealing dwell temperature T1, whereby heating and the dwell time t1 take place in the background magnetic field.

In the alternative method for producing a laminated core, a stack comprising a plurality of laminations made of a CoFe alloy containing 5 to 55 wt. % Co is provided. The stack is heat treated during final annealing in the background magnetic field for a dwell time t1 at a temperature T1, where T1 is between 700 °C and 960 °C, preferably 720 °C to 950 °C, preferably 760 °C to 920 °C, followed by cooling to a temperature of less than 200 °C. An external magnetic field is applied at least during cooling, this external magnetic field being greater than the background magnetic field.

Final annealing may be carried out in an inert gas atmosphere or a reducing atmosphere. The inert gas atmosphere may be pure nitrogen or argon. A hydrogen-containing atmosphere may be used as the reducing atmosphere. The hydrogen-containing atmosphere may be pure hydrogen or nitrogen and/or argon with the admixture of hydrogen. In one embodiment, the inert gas atmosphere or reducing atmosphere may be dry. In some embodiments, the hydrogen-containing atmosphere has an starting dew temperature of less than −40 °C

In both methods, i.e. the single-stage and the two-stage methods, the dwell time t1 may be between 0.5 and 10 hours, and/or cooling rates of between 10 K/h and 1000 K/h, preferably between 30 K/h and 300 K/h, may be used during cooling.

In some embodiments, the external magnetic field is applied in such a manner in relation to the stack that a preferred magnetic direction is generated in the laminations. For example, the external magnetic field may run approximately parallel to the main surfaces of the laminations. In some embodiments, the external magnetic field runs approximately parallel to the desired preferred direction.

The source of the specifically applied external magnetic field may be arranged within the chamber of the furnace. In some embodiments, at least one conductor, for example an electroconductive wire or cable through which current is able to flow, is arranged around the stack. For example, the wire may be wound around the stack, it being possible to use a plurality of windings to increase the magnetic field strength. To apply the external magnetic field, a voltage is applied to the conductor, causing current to flow through the conductor and a magnetic field to be generated around the conductor. As the conductor is arranged around the stack the magnetic field generated in this manner flows through the stack. To switch off the magnetic field, the voltage is removed from the conductor and the magnetic field ceases to be generated. Typically, a plurality of conductors or a plurality of windings of one or more conductors is used. This arrangement may be used with annular objects such as a stator ring or a cylindrical stator, the conductor being placed in the central opening and wound around the exterior of the annular object.

In some embodiments, the conductor has the form of copper rods that are connected to one another at the upper and lower parts of the annealing rack and so form an electrical circuit that includes the part to be annealed in the manner of a winding.

The current that flows through the conductor can be set so as to generate the desired magnetic field. In some embodiments, the current per conductor is greater than 5 A, preferably greater than 50 A, preferably greater than 100 A.

In some embodiments, magnetic field annealing is carried out in a magnetic field furnace that has an excitation magnetic field of greater than 50 kA/m, preferably greater than 100 kA/m, preferably between 100 kA/m and 300 kA/m. In a magnetic field furnace the conductor for generating the magnetic field is typically arranged outside the chamber or in the walls of the chamber.

In some embodiments, the external magnetic field is set such that the field strength in the CoFe alloy is greater than 0.5 A/cm, preferably greater than 1 A/cm, particularly preferably greater than 3 A/cm.

In some embodiments, at least one flux-conducting part is arranged at the stack and/or on the stack and/or under the stack in order to amplify the magnetic field in the laminations. The flux-conducting part may be made of a soft magnetic alloy such as a CoFe alloy, for example.

In some embodiments, rather than being integrated in the laminations and the stack the flux part is designed as a separate part, thereby forming an air gap. It is desirable for the air gap to be kept as small as possible to optimise the effectiveness of the flux part. In some embodiments, the air gap is no more than 0.1 mm, preferably no more than 0.05 mm, particularly preferably no more than 0.01 mm.

In some embodiments, the laminations are loose in the stack and are attached to form a laminated core after magnetic field annealing. In some embodiments, the laminations of the stack are attached to form a laminated core, and the laminated core is subjected to final annealing and subsequent magnetic field annealing if a separate process is being used for magnetic field annealing.

In some embodiments, a flux ring that forms a magnetic circuit with the stack or laminated core is provided. This increases the magnetic field in the stack or laminated core. In some embodiments, the flux ring is a part of each lamination or laminated core and is removed after magnetic field annealing. The flux ring may be removed by means of laser cutting or electrical discharge machining.

In some embodiments, the laminated core has the form of a stator with a stator ring and stator teeth. In these embodiments the flux guide has the form of an inner flux ring that extends between the inner ends of the stator teeth.

In some embodiments, the width of the inner flux ring is at least half the width of the stator teeth.

In some embodiments, the flux guide is a separate part rather than being integrated in the laminated core with the result that an air gap is formed between the laminated core and the flus guide. Every effort is made to keep the air gap as small as possible and so improve the effectiveness of the flux guide. In some embodiments, the air gap is no more than 0.1 mm, preferably no more than 0.05 mm, particularly preferably no more than 0.01 mm.

The laminated core may, for example, have an annular form or an elongated form. For example, an annular laminated core may be a stator ring, and an elongated laminated core may be a stator tooth. The laminated core may therefore be a segment of a stator.

In some embodiments, the laminated core is assembled from a plurality of parts or segments following magnetic field annealing.

In some embodiments, the laminated core is segmented into parts before final annealing, and the parts are heat treated in the externally applied magnetic field during both final annealing and magnetic field annealing. This embodiment has the advantage that the parts can be subjected to different magnetic field annealing processes. As a result, the magnetic field may, for example, be oriented parallel to the length of the stator teeth during one magnetic field annealing process and parallel to the circumferential direction of the stator ring in a further magnetic field annealing process. The magnetic properties of the parts can thus be optimised separately. In addition, final annealing may also serve to remedy damage caused by segmentation.

Alternatively, in some embodiments, the laminated core is not segmented into parts until after final annealing, and the parts are heat treated during magnetic field annealing in the externally applied magnetic field. This method permits the specific and separate optimisation of the magnetic properties.

In some embodiments, the parts are heated treated together with flux-conducting parts during magnetic field annealing in the externally applied magnetic field. In some embodiments, rather than being integrated in the laminations or the stack, the flux part is a separate part, and an air gap is thus formed between the flux part and the laminations or stack. It is desirable to keep the air gap as small as possible to optimise the effectiveness of the flux part. In some embodiments, the air gap is no more than 0.1 mm, preferably no more than 0.05 mm, particularly preferably no more than 0.01 mm.

In some embodiments, the laminations are loose in the stack. In a loose stack it is also possible to provide an integrated flux guide that forms part of the laminations. In some embodiments, the laminations take the form of a stator with a stator ring and stator teeth. In these embodiments, the laminations may have a flux guide in the form of an inner flux ring that extends between the inner ends of the stator teeth. In some embodiments, the width of the inner flux ring of the laminations is at least half the width of the stator teeth. In some embodiments, the flux ring is part of the lamination and is removed after magnetic field annealing. The flux ring may be removed by means of laser cutting, electrical discharge machining or punching.

In some embodiments, the flux guide is a separate part that is arranged at, on or under the stack. An air gap, which should be kept as small as possible, is typically formed between the stack and the flux guide. In some embodiments, the air gap is no more than 0.1 mm, preferably no more than 0.05 mm, particularly preferably no more than 0.01 mm.

In some embodiments, the laminations have an annular form or an elongated form.

For example, an annular lamination may take the form of a stator ring, and an elongated lamination may take the form of a stator tooth. The lamination may therefore be part of a segment of a stator.

In some embodiments, the laminations are assembled to form a laminated core and fastened together following magnetic field annealing and the removal of the flux ring where applicable. This can be carried out by means of glueing and/or welding.

The CoFe alloy may have different compositions. In some embodiments, the CoFe alloy may be a commercially available alloy such as HIPERCO or PERMENDUR. In some embodiments, the CoFe alloy consists of:
35 to 55 wt. % Co and up to 2.5 wt. % V, the rest being Fe and unavoidable impurities, or
45 wt. %≤Co≤52 wt. %, 45 wt. %≤Fe≤52 wt. %, 0.5 wt. %≤V≤2.5 wt. %, the rest being Fe and unavoidable impurities, or
35 wt. %≤Co≤55 wt. %, preferably 45 wt. %≤Co≤52 wt. %, 0 wt. %≤Ni≤0.5 wt. %, 0.5 wt. %≤V≤2.5 wt. %, the rest being Fe and unavoidable impurities, or
35 wt. %≤Co≤55 wt. %, 0 wt. %≤V≤2.5 wt. %, 0 wt. %≤(Ta+2Nb)≤1 wt. %, 0 wt. %≤Zr≤1.5 wt. %, 0 wt. %≤Ni≤5 wt. %, 0 wt. %≤C≤0.5 wt. %, 0 wt. %≤Cr≤1 wt. %, 0 wt. %≤Mn≤1 wt. %, 0 wt. %≤Si≤1 wt. %, 0 wt. %≤Al≤1 wt. %, 0 wt. %≤B≤0.01 wt. %, the rest being Fe and unavoidable impurities, or
5 to 25 wt. % Co, 0.3 to 5.0 wt. % V, 0 wt. %≤Si≤3 wt. %, 0 wt. %≤Cr≤3 wt. %, 0 wt. %≤Mn≤3 wt. %, 0 wt. %≤Al≤3 wt. %, the rest being Fe and unavoidable impurities, or
47 wt. %≤Co≤50 wt. %, 1 wt. %≤V≤3 wt. %, 0 wt. %≤Ni≤0.2 wt. %, 0.08 wt. %≤Nb≤0.12 wt. %, 0 wt. %≤C≤0.007 wt. %, 0 wt. %≤Mn≤0.5 wt. %, 0 wt. %≤Si≤0.1 wt. %, the rest being Fe and unavoidable impurities.

The laminations may be produced using metallurgical methods. In some embodiments, a molten mass of the FeCo alloy of the desired composition is provided and cast in a vacuum to form an ingot following subsequent solidification. The ingot is hot-rolled to form a slab, and the slab is then hot-rolled to form a hot-rolled strip. This is followed by the quenching of the hot-rolled strip from a temperature of above 700 °C to a temperature of less than 200 °C. The cooled hot-rolled strip is then cold-rolled to form a cold-rolled strip from which the laminations are formed. As a result, the laminations can have a cold-rolled texture prior to final annealing.

The laminations may be formed from the strip by means of cutting, punching, laser cutting, electrical discharge machining or cutting to length, for example. The laminations may have a thickness d_{b}, where 0.01 mm≤d_{b}<0.35 mm, preferably, 0.01 mm≤d_{b}<0.2 mm, preferably 0.01 mm≤d_{b}<0.1 mm, preferably 0.01 mm≤d_{b}<0.06 mm.

In some embodiments, the laminations are coated with a solution containing a Mg-containing methylate or a Mg-containing propylate or a Zr-containing methylate or a Zr-containing propylate or containing a boehmite-containing suspension, which transform into MgO or ZrO₂ or Al₂O₃ during heat treatment. Typically, the strip from which the laminations are formed is coated with the solution, and the laminations are formed with the coating from the coated strip. The coating may have a thickness dₛ, with 0.01 μm≤dₛ≤1 μm, 0.01 μm≤dₛ≤1 μm, preferably 0.01 μm≤dₛ≤0.5 μm, preferably 0.01 μm≤dₛ≤0.2 μm. In the case of a coating containing Al₂O₃, the thickness dₛ may also be greater, with 0.1 μm≤dₛ≤6 μm, preferably 0.5 μm≤dₛ≤4 μm.

In some embodiments, the laminations are coated with a boehmite-containing suspension that transforms into Al₂O₃ during heat treatment.

### BRIEF DESCRIPTION OF THE DRAWINGS

Embodiments and examples are explained in greater detail below with reference to the drawings.

FIG. 1 shows a perspective view of a stack of laminations that each take the form of a stator.

FIG. 2 shows graphs of three heat treatments.

FIG. 3 shows a view of a set-up for heat treating a stack in a longitudinal magnetic field.

FIG. 4 shows a hysteresis loop for a comparative example that is finally annealed in the background magnetic field, and for an example according to the invention in which a magnetic field is applied during the cooling phase of final annealing.

FIG. 5 shows a graph of measured permeabilities for laminations finally annealed in different longitudinal magnetic fields and for comparison laminations that are finally annealed without the application of an additional magnetic field.

FIG. 6 shows a graph of the curve of the maximum permeabilities and coercive field strengths as a function of longitudinal field.

FIG. 7 shows a graph of the curve of induction B3 at a field strength 3 A/cm, of remanence Br and of the remanence ratio Br/Bs as a function of longitudinal field.

FIG. 8 shows a graph of the remanence ratio Br/B160 for examples cooled in different magnetic fields.

FIG. 9 shows the magnetic properties Hc, B3, μmax and Br after “subsequent annealing”.

FIG. 10 shows a graph of the drop in μmax and Br/B3 after “subsequent annealing” at different temperatures.

FIG. 11 shows a graph of the permeabilities of the annealing processes carried out in a magnetic field and reference examples with no magnetic field.

FIG. 12A shows a view of a stator with a flux ring.

FIG. 12B shows a further view of the stator with the flux ring.

FIG. 12C shows a view of the stator after the removal of the flux ring.

FIG. 12D shows a view of a stator with a separate flux conductor.

FIG. 13 shows a stator tooth with a flux conductor.

FIG. 14 shows the distribution of flux density in the stator tooth with and without the flux conductor.

FIG. 15 shows different production routes by means of which it is possible to produce a laminated core or a part of a laminated core.

### DESCRIPTION OF EMBODIMENT(S) OF THE INVENTION

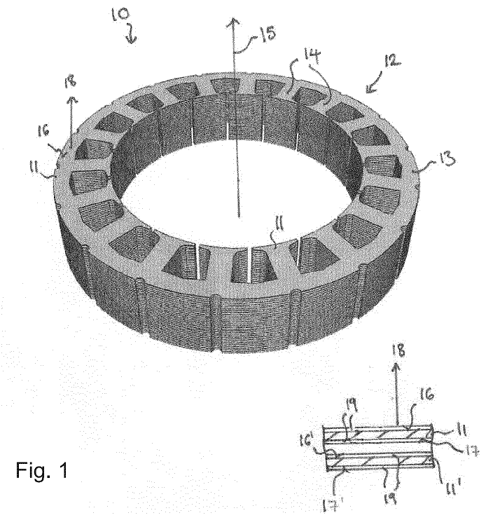

FIG. 1 shows a perspective view of a stack 10 comprising a plurality of laminations 11 that are made of a soft magnetic CoFe alloy. The CoFe alloy main contain between 5 and 55 wt. % cobalt. In one embodiment, the CoFe alloy contains approx. 49 wt. % Co, approx. 49 wt. % Fe and approx. 2 wt. % V. In addition to the main alloy elements of Co, Fe and V, some of these commercially available alloys also contain grain-refining additives such as Nb, Ta and Zr, for example, that limit grain growth and so permit increased strengths. The CoFe alloys available under the trade names VACOFLUX 48, VACOFLUX 50, VACODUR 50, VACODUR 49, VACODUR S Plus, HIPERCO 50, HIPERCO 50A, HIPERCO 50HS, AFK 502 and AFK 502R may be used as the CoFe alloy.

In the embodiment shown in FIG. 1, the laminations form a stator 12 having a stator ring 13 and a plurality of stator teeth 14 that extend from the inner face of the stator ring 13 in the direction of the axis 15 of the stator. In other embodiments, the laminations 11 may have a rectangular or square form or take the form of a part of a stator, e.g. an annular form in the case of the stator ring or a T-form or I-form in the case of a stator tooth.

The laminations 11 have a first main surface 16, a second main surface 17 arranged opposite the first main surface 16, and a thickness d_{b}, where 0.01 mm≤d_{b}<0.35 mm, preferably 0.01 mm≤d_{b}<0.2 mm, preferably 0.01 mm≤d_{b}<0.1 mm, preferably 0.01 mm≤d_{b}<0.06 mm. The second main surface 17 of a first lamination 11 is arranged on the first main surface 16 of a second lamination 11′ to construct the stack in a stacking direction 18 that extends perpendicular to the main surfaces 16 and 17.

One or both of the main surfaces 16, 17 of the laminations 11 may be completely or

partially coated with an electrically insulating coating 19 that serves as an annealing separator and provides electrical insulation between the laminations 11 in the finished laminated core. After final annealing, the coating 19 may contain a ceramic such as Al₂O₃, MgO or ZrO₂.

In the embodiment shown in FIG. 1, the laminations 11 of the stack 10 are loose and not connected to one another. In other embodiments, the laminations are connected to one another by means or one or more weld seams, for example, and form a laminated core or a segment of a laminated core, e.g. of a stator ring or stator tooth.

The stack 10 is subjected to heat treatment to set the soft magnetic properties of the CoFe alloy.

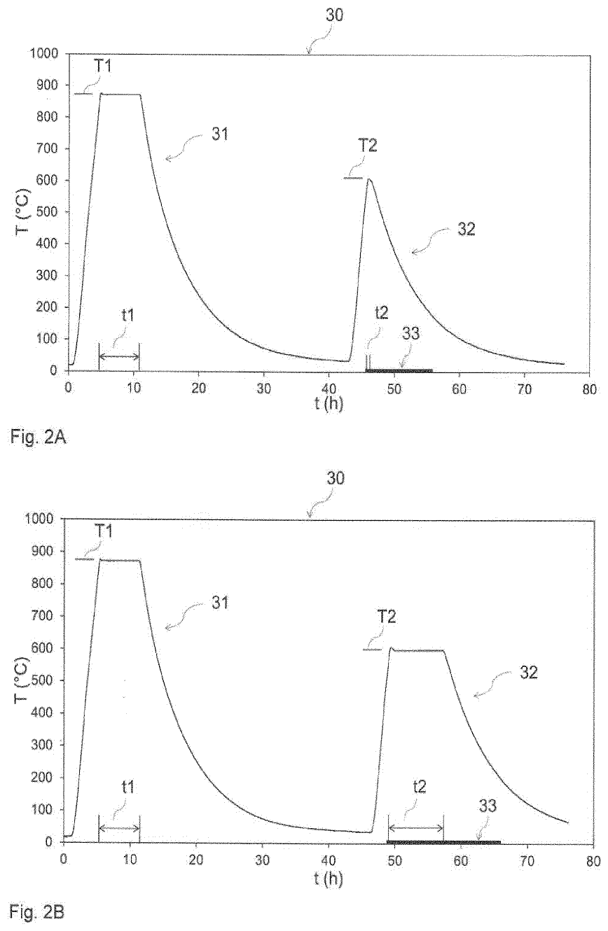

FIG. 2 shows graphs of three examples of possible heat treatments for a CoFe alloy containing 5 to 55 wt. % Co. These heat treatments may be used to produce a laminated core, a stack of laminations of the CoFe alloy or segments and parts of a stator.

FIG. 2A shows an embodiment of a heat treatment method 30 comprising two separate stages, i.e. final annealing 31, followed by separate magnetic field annealing 32. During final annealing 31, the stack is heated and held for a time t1 at a temperature T1, then cooled to a temperature of less than 300 °C. The stack may be cooled to room temperature and then stored. Following this final annealing, magnetic field annealing 32 is carried out. This may take place at a later time following storage of the stack at room temperature. During magnetic field annealing, the stack is heated and held for a time t2 at a temperature T2, then cooled to a temperature of less than 300 °C. An external magnetic field is applied for at least part of magnetic field annealing.

The length of time for which the external magnetic field is applied is indicated by the black bar 33 in FIG. 2. Outside this region, heat treatment is carried out in the background magnetic field. The background magnetic field is typically no more than 1 kA/m, preferably less than 0.5 kA/m, preferably less than 0.1 kA/m. The external magnetic field, which is applied actively, is therefore greater than the background magnetic field, i.e. greater than 0.1 kA/m. In some embodiments, the external magnetic field is set so as to produce a field strength greater than 0.5 A/cm, preferably greater than 1 A/cm, particularly preferably greater than 3 A/cm at the stack.

In the embodiment in FIG. 2A, the dwell time t2 is short, e.g. half an hour, and the magnetic field is applied once the temperature T2 has been reached and then held until a temperature of approximately 200 °C is achieved as a result of subsequent cooling from the dwell temperature T2. The external magnetic field can then be switched off and cooling to low temperature can be carried out in the background magnetic field.

FIG. 2B also discloses a two-stage heat treatment 30 comprising final annealing 31 followed by separate magnetic field annealing 32. This heat treatment 30 differs from the heat treatment 30 shown in FIG. 2A in the length of the dwell time t2, which is longer, e.g. 6 hours. In this embodiment, the magnetic field is applied for the entire dwell time t2 and during cooling to a temperature of approximately 200 °C. In other embodiments (not shown), the magnetic field is applied only during cooling from temperature T2, i.e. on expiry of time period t2, or is not applied until the dwell time such that a first period of the dwell time t2 takes place in the background of the magnetic field and a subsequent period of the dwell time t2 and cooling take place in the externally applied magnetic field.

The use of two separate annealing processes, which may be similar to the examples shown in FIGS. 2A and 2B in terms of final annealing and subsequent magnetic field annealing, has the advantage that different process parameters can be optimised and selected for each heat treatment. One such example is cooling rate: during final annealing it must be sufficiently high to avoid dwelling in the γ2 phase; during magnetic field annealing it must be sufficiently low to take into account the setting of a short-range order. Different types of furnace may be used. This offers technical advantages in terms of temperature accuracy, for example, but also logistical advantages. Different annealing atmospheres may be used, e.g. hydrogen for final annealing and a vacuum or inert gas atmosphere for magnetic field annealing.

FIG. 2C illustrates a heat treatment process 30′ according to another embodiment in which magnetic field annealing is integrated in final annealing 31, resulting in a single-stage heat treatment 30′ process. In this embodiment, the stack is heated to a temperature T1 in the background magnetic field, and this temperature T1 is maintained for a dwell time t1. After this dwell time t1, the stack is cooled to a temperature of less than 300 °C. An external magnetic field is applied at least during cooling, as indicated schematically by the bar 33 in FIG. 2C. In this example, the magnetic field is switched on during the second half of dwell time t1 and remains switched on during cooling to a temperature of approximately 250 °C. The external magnetic field may then be switched off and further cooling to lower temperatures carried out in the background magnetic field. In other embodiments (not shown), the magnetic field may be applied earlier, e.g. during dwell time t1.

The cooling rate for final annealing and separate magnetic field annealing may be between 10 K/h and 1000 K/h, for example between 30 K/h and 300 K/h, with the cooling rate being able to vary within this range during cooling. As illustrated in FIG. 2, the cooling rate generally slows as temperature drops.

In all heat treatments the magnetic field may be applied in such a manner in relation to the orientation of the stack 10 as to generate a preferred magnetic direction in the laminations 11. In particular, the magnetic field may be applied such that it runs approximately parallel to the main surfaces 16, 17 of the laminations 11. In addition, the external magnetic field may run approximately parallel to the desired preferred direction in the laminations 11. For example, the magnetic field may be applied in such a manner in relation to the stator shown in FIG. 1 as to extend along the length of the stator teeth 14.

In a further embodiment in which the laminations 11 of the stack 10 are a part of a stator, e.g. a stator tooth, the magnetic field may run not only parallel to the main surfaces, but also parallel to the longitudinal direction of the stator tooth. In one embodiment, in which the laminations take the form of a stator ring, the magnetic field may be applied, or the laminations be oriented in such a manner in relation to the magnetic field that the magnetic field extends in the circumferential direction of the ring and parallel to the main surfaces.

The externally applied magnetic field may be generated in various manners. For example, the stack may be placed in a so-called magnetic field furnace that has a switchable magnetic field source. The switchable magnetic field source may be a coil system that is placed inside or outside the walls of the furnace. The stack may be placed in the chamber of the furnace in such a manner in relation to the magnetic field source of the furnace that the magnetic field runs in the desired preferred direction of the part. Alternatively, one or more electroconductive conductors may be wound around the stack and this setup may be arranged in a furnace. A current flowing through the conductor then generates the magnetic field. Such arrangements can be referred to as longitudinal magnetic fields (LF).

In the event that a stator ring and individual teeth are manufactured separately, longitudinal magnetic field annealing is provided for the stator ring. During this process the necessary longitudinal magnetic field is generated during annealing by means of energised conductors. The individual teeth, on the other hand, are annealed in a magnetic field furnace. During this process, the individual teeth are oriented in such a manner in the magnetic field that the magnetisation direction imposed by the field corresponds as far as possible to the magnetisation direction in the subsequent application.

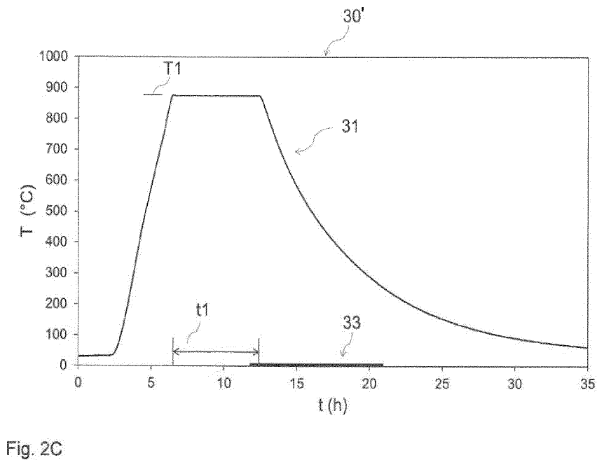

FIG. 3 shows a view of a set-up 40 for heat treating a stack 41 in a longitudinal magnetic field. In this embodiment, the laminations are all annular in form and have a central opening 43 such that the stack 41 of loose laminations has the form of a tube. In this embodiment, six coils of a conductor 42 are wound around the stack 41. The conductor 42 extends through the opening 43 and then adjacent to the edge of the stack 41 to form the six coils. The conductor 42 may be a copper conductor. The copper conductors are electrically insulated from one another and from the furnace walls by ceramic tubes and connected to an amplifier (not shown) to supply direct current.

The external magnetic field is generated by energising electrical conductors 42 that run perpendicular to the lamination plane and generate a magnetic field parallel to the subsequent direction of magnetic stress of the parts, i.e. the main surface of the laminations, thereby generating a longitudinal magnetic field.

### EXAMPLES

Annealing tests were carried out with CoFe alloy rings in a longitudinal magnetic field. To this end, Ø38.1 mm×Ø31.75 mm stamped rings of VACODUR 49 were wound with bare Ø2 mm copper wire in a ceramic trough. To ensure that the conductors were electrically insulated from one another and from the furnace ceramic tubes with a Ø3 mm central hollow were threaded over the copper wire, as shown in FIG. 3.

Two series of measurements were carried out. In a first series of measurements, heat treatment is carried out according to FIG. 2C, and a magnetic field active is applied in the cooling phase of final annealing for 6 hours at 880 °C. A second series of measurements investigates a two-stage method in which, following heat treatment according to FIGS. 2A and 2B, final annealing is carried out for 6 hours at 800 °C separately from subsequent magnetic field annealing. An external magnetic field is applied for at least part of magnetic field annealing. Final annealing takes place in the background magnetic field.

### First Measurement Series

In a first series of measurements, the external magnetic field is applied during the cooling phase of final annealing for 6 h at 880 °C and varied by varying the current applied. The current strengths used, I=0/0.5/1/2.5/5/10/20 A, correspond to magnetic fields at the location of the rings of H=0/0.27/0.5/1.37/2.74/5.47/10.9 A/cm. A new sample is wound and annealed for each current.

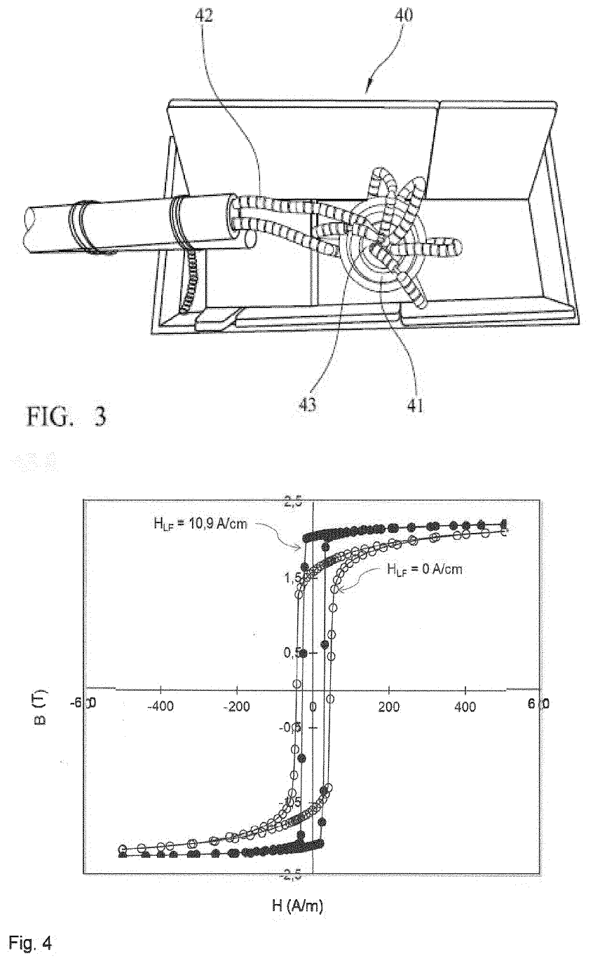

FIG. 4 shows a hysteresis loop for a comparative example of a lamination made of VACODUR 49 that is finally annealed for 6 hours at 800 °C in the background magnetic field only without the application of an additional magnetic field because H(LF)=0 A/cm, and for an example according to the invention in which a magnetic field H(LF) of 10.9 A/cm is applied during the cooling phase of final annealing. FIG. 4 shows a rectangular Z-loop for the example according to the invention that is cooled in a longitudinal magnetic field, while the comparative example subjected to final annealing with no additional, externally applied magnetic field and only in the background magnetic field has a round R-loop. This comparison shows that the use of the additional, externally applied magnetic field during the cooling phase of final annealing results in anisotropic magnetic properties and thus in a preferred direction of magnetic properties in the laminations.

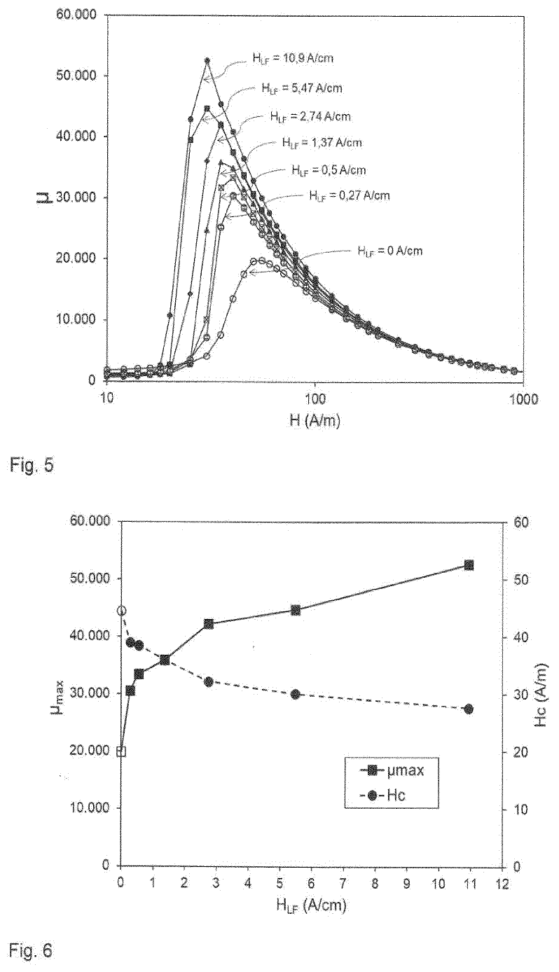

FIG. 5 shows a graph of measured permeabilities (μ) for the laminations finally annealed in different longitudinal magnetic fields and for a comparison lamination that is finally annealed without an additionally applied magnetic field. The highest field applied of 10.9 A/cm generates a maximum permeability of over 50,000, which is 2.5 times as high as that of the comparative example with no externally applied magnetic field, which has a maximum permeability of 20,000.

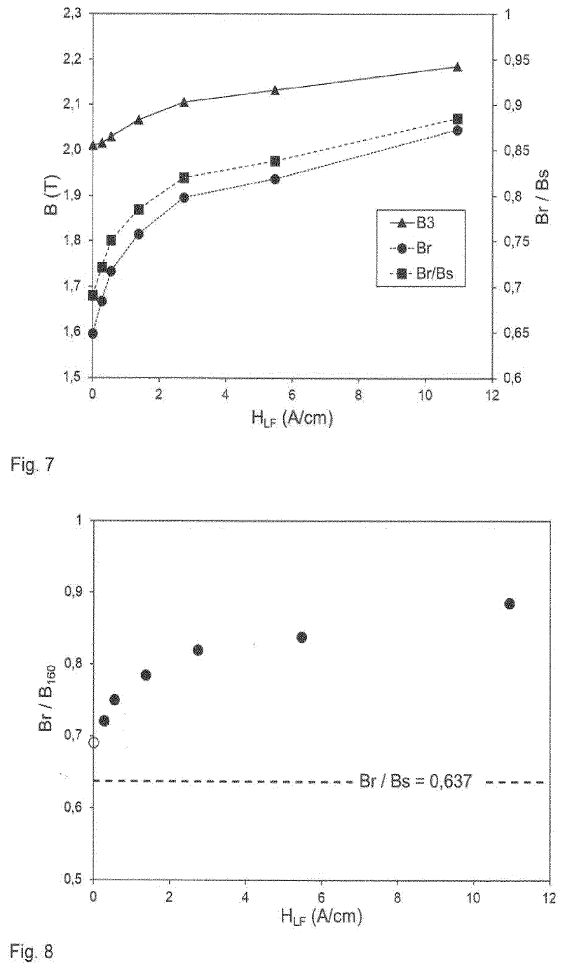

FIG. 6 shows a graph of the curve of the maximum permeabilities (μₘₐₓ) and coercive field strengths as a function of longitudinal field. For these examples, maximum permeability (μₘₐₓ) rises, and coercive field strength (Hc) falls as the magnetic field strength increases.

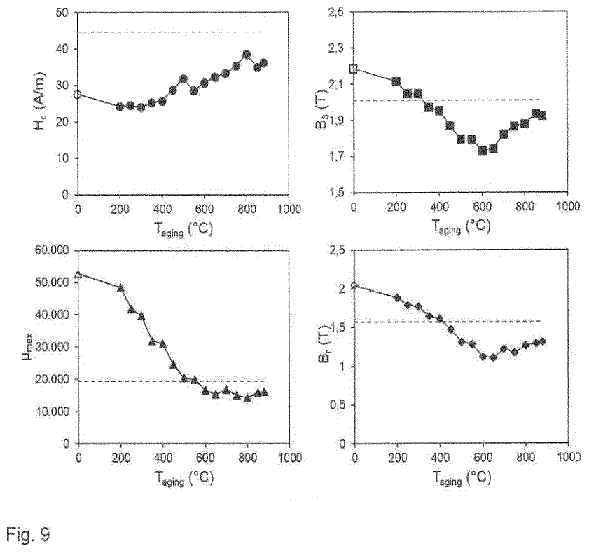

FIG. 7 shows a graph of the curve of inductions at a field strength 3 A/cm (B3), of remanence (Br) and of remanence ratio (Br(Bs) as a function of the longitudinal field.

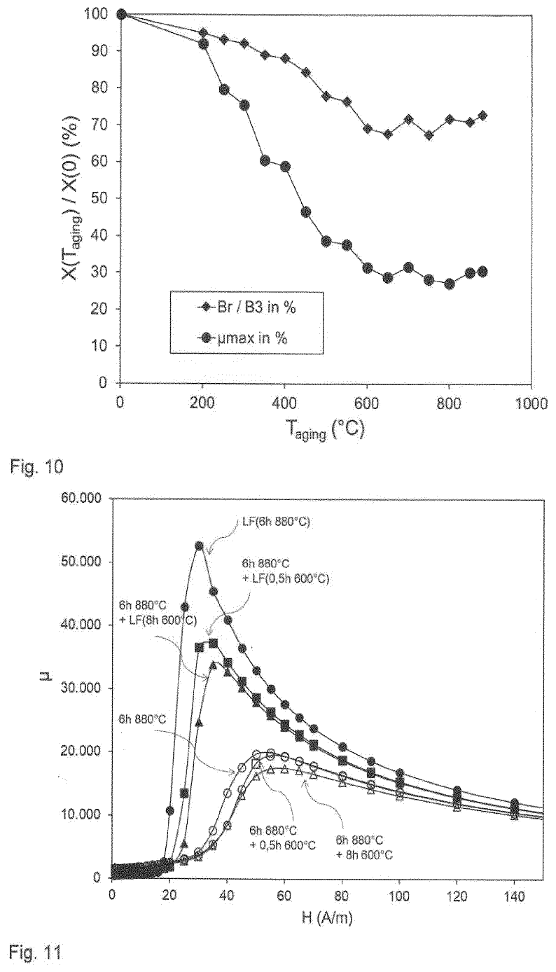

FIG. 8 shows a graph of the remanence ratio Br/B160 for examples cooled in different magnetic fields. FIG. 8 shows an increase in remanence ratio as longitudinal field increases. An isotropic domain distribution (perfectly round R-loop, no anisotropy) would generate a remanence ratio of 0.637, as illustrated by the broken line in FIG. 8.

Table 1 shows characteristic magnetic values for the samples after final annealing with a longitudinal magnetic field H_{LF} applied during cooling, this longitudinal magnetic field H_{LF} being generated with a current I_{F} in the conductor. Table 2 shows the activity of the longitudinal magnetic field LF during the cooling phase of final annealing.

TABLE 1

| | | | | | B3 = | B160 = | | |
|---|---|---|---|---|---|---|---|---|
| | I_{LF} | H_{LF} | Hc | | B(3 A/cm) | (160 A/cm) | Br | |
| Sample | (A) | (A/cm) | (A/m) | μmax | (T) | (T) | (T) | Br/B₁₆₀ |
| 2002506 | 0 | 0.00 | 44.4 | 19898 | 2.010 | 2.313 | 1.597 | 0.690 |
| 2002869 | 0.5 | 0.27 | 39.0 | 30539 | 2.015 | 2.314 | 1.669 | 0.721 |
| 2002535 | 1 | 0.55 | 38.5 | 33431 | 2.030 | 2.309 | 1.734 | 0.751 |
| 2002873 | 2.5 | 1.37 | 35.9 | 35927 | 2.067 | 2.312 | 1.816 | 0.785 |
| 2002517 | 5 | 2.73 | 32.2 | 42226 | 2.106 | 2.313 | 1.897 | 0.820 |
| 2002504 | 10 | 5.47 | 30.1 | 44703 | 2.134 | 2.310 | 1.938 | 0.839 |
| 2002522 | 20 | 10.94 | 27.6 | 52636 | 2.186 | 2.310 | 2.046 | 0.886 |

TABLE 2

| | | Switch-on | Switch-off |
|---|---|---|---|
| LF- annealing | Time LF | temperature | temperature |
| Energisation in A | active in h | LF in °C | LF in °C |
| 0.5 | 8:42 | 874 | 283 |
| 1 | 8:58 | 874 | 267 |
| 2.5 | 8:36 | 874 | 289 |
| 5 | 8:11 | 874 | 295 |
| 10 | 8:46 | 874 | 276 |
| 20 | 9:18 | 874 | 265 |

The extent to which the improved magnetic properties were maintained during the operation of the laminated core when the laminated core was exposed to increased temperatures was also investigated. This was done by means of what is referred to here as “subsequent annealing”. This subsequent annealing does not form part of the production process. It simply serves to determine the temperature resistance of the magnetic properties.

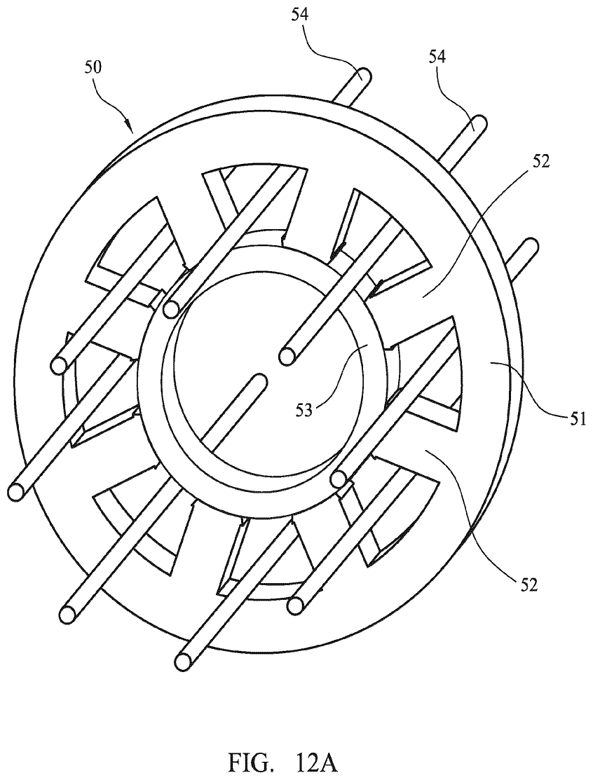

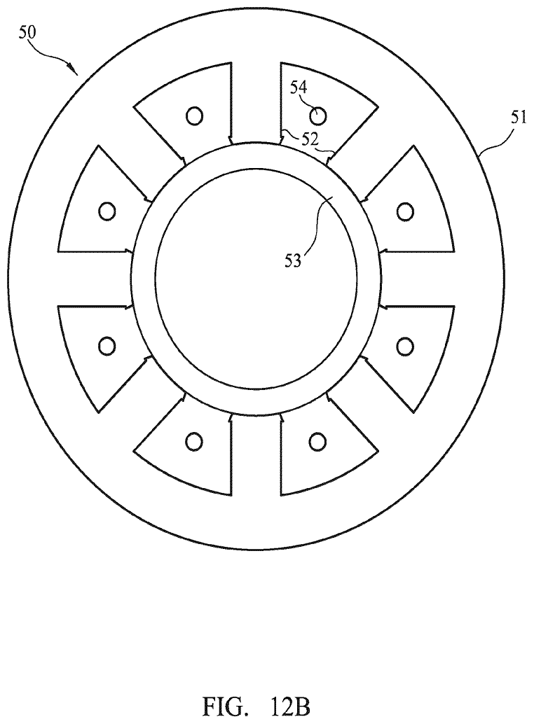

FIG. 9 shows the magnetic properties Hc, B3, μmax and Br following subsequent annealing of the I=20A annealed sample at a temperature of between 200 °C and 880 °C in 50 °C steps. In each case, subsequent annealing was carried out for 1h. B3 and Br exhibit a local minimum value in a temperature range of between 60° and 650 °C. FIG. 10 shows a graph of the drop in μₘₐₓ and Br/B3 as the temperature of subsequent annealing increases.

These results show that the improvement in magnetic properties in comparison to the comparative example, which was finally annealed with no additional magnetic field, is maintained at high temperatures of up to approximately 300 °C. The laminations are therefore suitable for applications in which they are exposed to high temperatures.

### Second Measurement Series

In this series of measurements, magnetic final annealing is carried out for 6 hours at 880 °C in the background magnetic field, and magnetic field annealing is carried out separately at 600 °C.

Following final annealing in the background magnetic field, one of two different magnetic field annealing processes is carried out. One has a half-hour dwell time with the magnetic field being actively applied 15 minutes before the start of cooling and during cooling to below 200°. The other has an eight hour dwell time at 800 °C with the magnetic field being applied for the entire dwell time and during cooling to below 200 °C. The corresponding heat treatment processes are shown in FIGS. 2A and 2B. Reference samples not exposed to the field were also tested during both annealing processes.

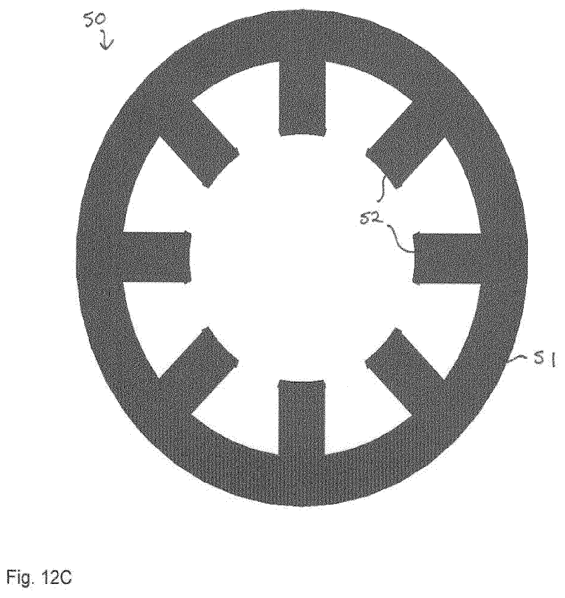

FIG. 11 shows a graph of the permeabilities of the annealing processes with magnetic field and reference examples with no magnetic field. Table 3 shows magnetic values for the separate final annealing and magnetic field annealing process from FIG. 11. Sample numbers 2002506 and 2002522 from Table 1 are included for reference.

TABLE 3

| | | | | | | B3 = | B160 = | | | |
|---|---|---|---|---|---|---|---|---|---|---|
| | I_{LF} | H_{LF} | T_{LF} | Hc | | B(3 A/cm) | (160 A/cm) | Br | | |
| Sample | (A) | (A/cm) | (°C) | (A/m) | μmax | (T) | (T) | (T) | Br/B₁₆₀ | Condition |
| 2200009 | 0 | 0 | 600 | 47.2 | 19,469 | 2,035 | 2.291 | 1.618 | 0.706 | 0 A 0.5 h |
| | | | | | | | | | | 600 °C |
| 2200008 | 20 | 10.94 | 600 | 32.3 | 37,261 | 2,084 | 2.305 | 1.843 | 0.800 | 20 A 0.5 h |
| | | | | | | | | | | 600 °C |
| 2200012 | 0 | 0 | 600 | 48.3 | 17,450 | 1,994 | 2.361 | 1.562 | 0.662 | 0 A 8 h 600 °C |
| 2200011 | 20 | 10.94 | 600 | 34.1 | 33,855 | 2,075 | 2.304 | 1.831 | 0.795 | 20 A 8 h 600 °C |
| 2002506 | 0 | 0 | — | 44.4 | 19,898 | 2,031 | 2.315 | 1.597 | 0.690 | 0 A |
| 2002522 | 20 | 10.94 | 880 | 27.6 | 52,636 | 2,186 | 2.310 | 2.046 | 0.886 | 20 A |

FIG. 11 shows that magnetic field annealing for 8 h at 600 °C produces poorer magnetic characteristics than magnetic field annealing for 0.5 h at 600 °C. This is presumably due to the fact that 50% CoFe alloys have a separation region of a V-rich phase between 500 °C and 650 °C phase, also referred to as a γ2 phase. To avoid magnetically disadvantageous separations this region should be passed through quickly after final annealing. The cooling rate should also be high enough to set the zero crossing of the magnetocrystalline anisotropy constant K1, which is a function of both Co content and order state. Typical cooling rates after final annealing lie in the range of 100 to 200 °C/h. During magnetic field annealing it may be advantageous to select another cooling rate in order to set the near-order. To set different cooling rates it may therefore be advantageous to carry out magnetic final annealing and magnetic field annealing separately from one another with different temperature profiles.

A flux conductor and/or a flux guide (back iron) may be used to increase the magnetic field at the stack or the laminations.

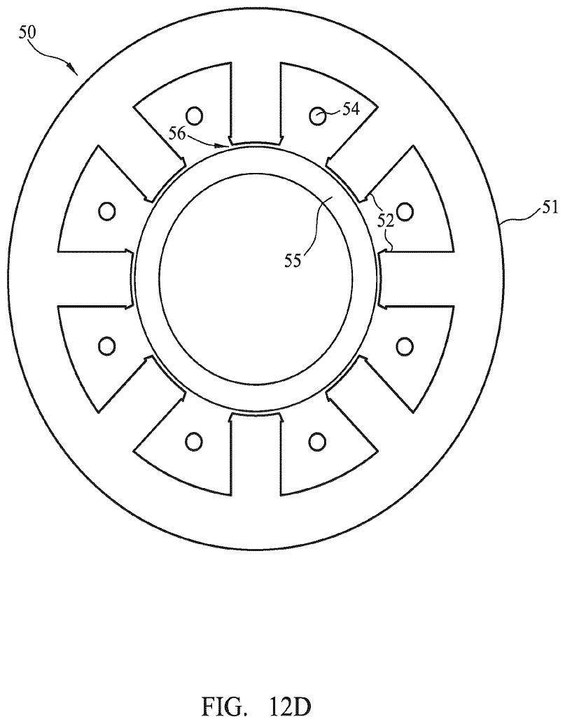

FIGS. 12A and 12B show a schematic perspective view and a plan view respectively of a stator 50 with a stator ring 51 and stator teeth 52. It also has an integrated inner flux ring 53 that extends between the inner ends of the stator teeth 52. FIG. 12A also shows the electroconductive conductors 54 that are arranged in the spaces of the stator. After magnetic field annealing, the inner flux ring 53 is removed by means of electrical discharge machining or laser cutting, for example, in order to produce the stator 50 with stator ring 51 and stator teeth 52 illustrated in FIG. 12C.

A further possible way of generating sufficient flux density in an individual tooth despite the limitation of the external magnetic field strength is to use an additional soft magnetic part 55, which can be referred to as a “flux conductor”. It concentrates additional magnetic air flow and conducts it further into the individual tooth. In such an arrangement the flux conductor 55 may take different forms. One example is illustrated in FIG. 12D in which the flux conductor 55 has the form of an inner flux ring 53 that is separated from the adjacent stator teeth 52 by an air gap 56. Analogously, in a stator designed as an external rotor an outer flux ring could be used as the flux conductor.

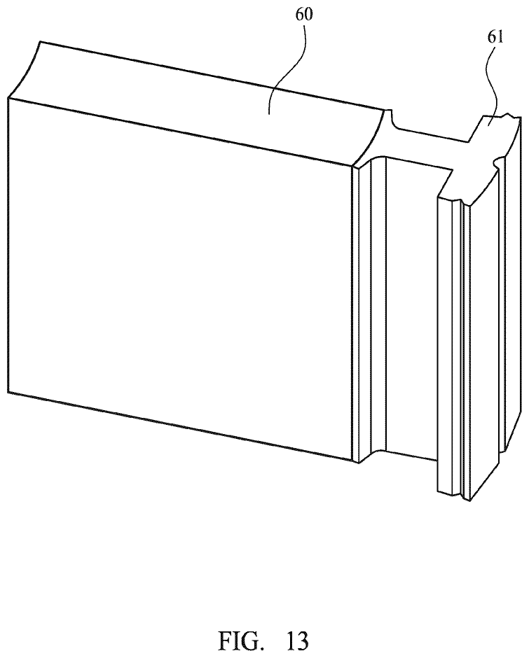

A further example is illustrated in FIG. 13, in which the flux conductor 60 has the form of an elongated rectangular cuboid that fits flush with the individual tooth. In other embodiments, it is possible to use a separate flux conductor that is arranged as close as possible to the stack so that any air gap between flux conductor and stack is kept small.

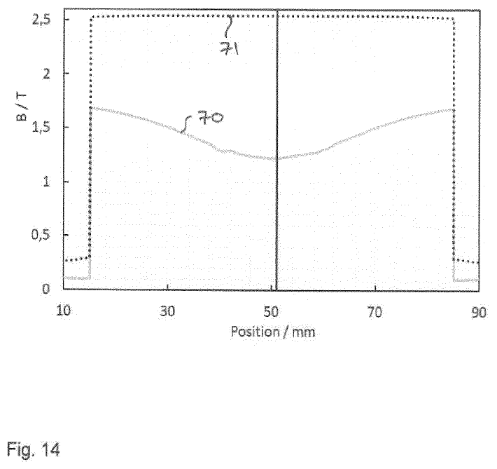

FIG. 14 shows the distribution of flux density in the stator tooth with and without flux conductors as a function of height, mean height being indicated by the black vertical line. The flux density that can be achieved in the tooth is not necessarily distributed homogenously over the tooth height, as shown by curve 70. In contrast, when a flux conductor is used the regions that are more difficult to saturate are also fully magnetised, as illustrated by curve 71. With a flux conductor of this type it is therefore possible to anneal individual teeth in an external magnetic field so as to set a preferred magnetic direction more effectively. If possible, there is preferably no air gap between the flux conductor and the stator tooth. In order to avoid the need to weld the parts, one or both of the parts may have an annealing-resistant coating. Alternatively, the parts should be separated from one another by an annealing separator such as ceramic annealing powder prior to annealing.

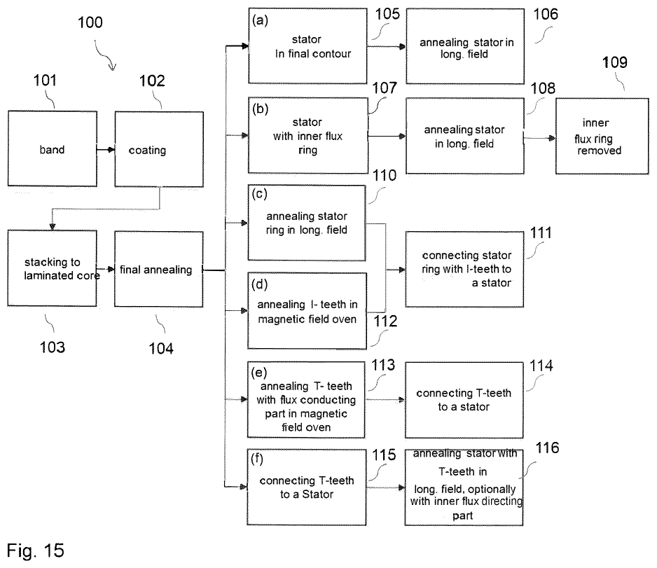

FIG. 15 shows six different production routes 100 by means of which a laminated core or a part of a laminated core can be produced.

The first four steps are carried out for all six of the production routes. In box 101 a strip of a CoFe alloy with one of the compositions described here is provided. This strip may be produced using metallurgical methods. For example, a molten mass of the FeCo alloy of the desired composition is provided and cast in a vacuum to form an ingot following subsequent solidification. The ingot is hot-rolled to form a slab, and the slab is then hot-rolled to form a hot-rolled strip. This is followed by the quenching of the hot-rolled strip from a temperature of above 700 °C to a temperature of less than 200 °C. The cooled hot-rolled strip is then cold-rolled to form a cold-rolled strip.

Then, in box 102, the strip is coated with an electrically insulating layer or a layer that is able to form an electrically insulating layer after heat treatment. A plurality of laminations is then formed from the coated strip and then stacked and connected to form a laminated core in box 103. These laminations may, for example, be stacked to form a laminated core by means of in-die stacking and fixed together by means of a heat-resistant connection or connections, e.g. at least one laser weld seam or laser weld spots. Then, in box 104, the laminated core is subjected to final annealing according to one of the embodiments described here. The laminated core may take different forms. The following steps of the production process including magnetic field annealing are adapted to this form.

In the first production route (a), in box 105, the laminated core has the form of a stator. In general, the laminated core is designed as a full section and already has its final shape at the time of final annealing. The laminated core in its final shape or the stator is then annealed in the longitudinal magnetic field in box 106. For example, the set-up shown in FIG. 3 may be used.

In the second production route (b), in box 107, the laminated core has an integrated flux guide. In this embodiment the laminated core has the form of a stator with an inner flux ring that extends between the inner ends of the stator teeth. In box 108 the stator is annealed in the longitudinal magnetic field with the inner flux ring. Here, the set-up illustrated in FIG. 12A may be used. In box 109, the inner flux ring is then removed by means of laser cutting, for example.

In the third production route (c), the laminated core has the form of a stator ring. The stator ring is annealed in the longitudinal magnetic field. For example, the set-up illustrated in FIG. 3 may be used. In the fourth production route (d), in box 112, the laminated core has the form of a stator tooth that may be I-shaped. Typically, a plurality of stator teeth is provided and finally annealed. The stator teeth are subjected to magnetic field annealing in a magnetic field furnace. The magnetic field may run along the main surface and longitudinal direction of the stator teeth.

The third and fourth production routes can then be combined by joining the stator ring from the third production route to the stator teeth from the fourth production route to form a stator in box 111.

In the fifth production route (e), in box 113, one or more T-shaped stator teeth are annealed in the magnetic field furnace. These stator teeth may be subjected to magnetic field annealing with one or more flux-conducting parts. These flux-conducting parts may be separate parts or may be connected to the corresponding stator tooth or integrated in the corresponding stator tooth. In these embodiments, the flux-conducting part is removed from the stator tooth after magnetic field annealing, e.g. by laser cutting. The T-shaped stator teeth are then joined to a stator in box 114.

In the sixth production route (f), the laminated core or laminated cores take the form of a T-shaped stator tooth or teeth. These stator teeth are first connected to a stator in box 115. The assembled stator is then annealed in a longitudinal magnetic field in box 116. For example, the set-up shown in FIG. 3 may be used. Optionally, an inner flux guide that extends between the inner ends of the stator teeth may be used, as shown in FIG. 12D. Here, however, rather than being connected cohesively the flux guide is attached to the T-teeth with the smallest possible air gap.

The production routes illustrated in FIG. 15 may also be modified by restricting the in-die stacking described in box 103 to the stacking of loose laminations such that the cohesive connection of laminations to form a laminated core does not take place until after final annealing or magnetic field annealing.

1. A method for producing a CoFe alloy for a laminated core, the method comprising the following:
providing a stack comprising a plurality of laminations made of a CoFe alloy containing 5 to 55 wt. % Co,
heat treating the stack during final annealing in the background magnetic field for a dwell time t1 at a temperature T1, T1 being between 700 °C and 960 °C, preferably 720 °C to 950 °C, preferably 760 °C to 920 °C, followed by cooling to a temperature of less than 300 °C, preferably less than 200 °C, and then
heat treating the stack for part of magnetic field annealing in an externally applied magnetic field for a dwell time t2 at a temperature T2, T2 being between 500 °C and T1, preferably between 650 °C and T1, preferably between 700 °C and T1, followed by cooling to a temperature of less than 300 °C, preferably less than 200 °C, the externally applied magnetic field being greater than the background magnetic field.

2. A method according to claim 1, wherein the final annealing and magnetic field annealing are carried out in different furnaces.

3. A method according to claim 1, wherein the external magnetic field is applied only during cooling to a temperature of less than 300 °C, preferably less than 200 °C.

4. A method according to claim 1, wherein the external magnetic field is applied for a dwell time t2 and during subsequent cooling to a temperature of less than 300 °C, preferably less than 200 °C.

5. A method according to claim 1, wherein the external magnetic field is applied for less than 50% of the dwell time t2 and during the subsequent cooling to a temperature of less than 300 °C, preferably less than 200 °C.

6. A method according to claim 1, wherein the magnetic field is not applied until the second half of the dwell time t2 and during the subsequent cooling to a temperature of less than 300 °C, preferably less than 200 °C.

7. A method according to claim 1, wherein t2 is between one minute and 10 hours.

8. A method for producing a laminated core, the method comprising the following:
providing a stack comprising a plurality of laminations made of a CoFe alloy containing 5 to 55 wt. % Co,
heat treating the laminated core during final annealing in the background magnetic field for a dwell time t1 at a temperature T1, T1 being between 700 °C and 960 °C, preferably 720 °C to 950 °C, preferably 760 °C to 920 °C, followed by cooling to a temperature of less than 200 °C, an external magnetic field being applied for at least part of cooling, the external magnetic field being greater than the background magnetic field.

9. A method according to claim 1, wherein t1 being is 0.5 and 10 hours and/or cooling rates of between 10 K/h and 1000 K/h, preferably between 30 K/h and 300 K/h, are used during cooling.

10. A method according to claim 1, wherein the external magnetic field is applied in such a manner in relation to the stack as to generate a preferred magnetic direction in the laminations.

11. A method according to claim 1, wherein the external magnetic field runs approximately parallel to the main surfaces of the laminations.

12. A method according to claim 1, wherein the external magnetic field runs approximately parallel to the desired preferred direction.

13. A method according to claim 1, wherein at least one conductor through which a current is able to flow is arranged around the stack, and a voltage being applied to this conductor in order to apply the external magnetic fields such that current flows through the conductor.

14. A method according to claim 13, wherein the current per conductor is greater than 5 A, preferably greater than 50 A, preferably greater than 100 A.

15. A method according to claim 1, wherein magnetic field annealing is carried out in a magnetic field furnace that has an excitation magnetic field of greater than 50 kA/m, preferably greater than 100 kA/m, preferably between 100 kA/m and 300 kA/m.

16. A method according to claim 1, wherein at least one flux-conducting part is arranged at the stack and/or on the stack and/or under the stack in order to strengthen the magnetic field in the laminations.

17. A method according to claim 1, wherein the external magnetic field is set such that there is a field strength of greater than 0.5 A/cm, preferably greater than 1 A/cm, particularly preferably greater than 3 A/cm, in the CoFe alloy.

18. A method according to claim 1, wherein after magnetic field annealing the CoFe alloy has a remanence ratio Br/Bs of greater than or equal to 0.8, the remanence Br and the magnetic saturation Bs being measured at 160 A/cm, and/or a maximum permeability μₘₐₓ of over 25,000, preferably over 30,000, particularly preferably over 40,000.

19. A method according to claim 1, wherein the laminations of the stack are fastened together to form a laminated core, and the laminated core is subjected to final annealing.

20. A method according to claim 1, further comprising a flux guide that forms a magnetic circuit together with the laminated core.

21. A method according to claim 20, wherein the laminated has the form of a stator having a stator ring and stator teeth, and the flux guide has the form of an inner flux ring that extends between the inner ends of the stator teeth.

22. A method according to claim 21, wherein the width of the inner flux ring is at least half the width of the stator teeth.

23. A method according to claim 21 or claim 22, wherein the flux ring is part of the laminated core and is removed after magnetic field annealing.

24. A method according to claim 23, wherein the flux ring is removed by means of laser cutting or electrical discharge machining.

25. A method according to claim 21, wherein an air gap is formed between the laminated core and the flux guide, this air gap being no more than 0.1 mm, preferably no more than 0.05 mm, particularly preferably no more than 0.01 mm.

26. A method according to claim 19, wherein the laminated core has an annular or elongated form.

27. A method according to claim 26, wherein after magnetic field annealing the laminated core is assembled from a plurality of parts.

28. A method according to claim 11, wherein the laminated core is segmented into parts before or after final annealing and these parts are heat treated in the externally applied magnetic field during magnetic field annealing.

29. A method according to claim 28, wherein the parts are heat treated together with flux-conducting parts in the externally applied magnetic field during magnetic field annealing.

30. A method according to claim 1, wherein the laminations are loose in the stack.

31. A method according to claim 30, further comprising a flux guide that forms a magnetic circuit together with at least one of the laminations.

32. A method according to claim 31, wherein the laminations have the form of a stator with a stator ring and stator teeth, and the flux guide has the form of an inner flux ring that extends between the inner ends of the stator teeth.

33. A method according to claim 32, wherein the width of the inner flux ring is at least half the width of the stator teeth.

34. A method according to claim 32, wherein the flux ring is a part of the lamination and is removed after magnetic field annealing.

35. A method according to claim 34, wherein the flux ring is removed by means of laser cutting or electrical discharge machining.

36. A method according to claim 31, wherein an air gap is formed between the stack and the back ring, this air gap being no more than 0.1 mm, preferably no more than 0.05 mm, particularly preferably no more than 0.01 mm.

37. A method according to claim 30, wherein the laminations have an annular or elongated form.

38. A method according to claim 37, wherein after magnetic field annealing the laminations are assembled to form a laminated core.

39. A method according to claim 1, the CoFe alloy comprising:
35 to 55 wt. % Co and up to 2.5 wt. % V, the rest being Fe and unavoidable impurities, or
45 wt. %≤Co≤52 wt. %, 45 wt. %≤Fe≤52 wt. %, 0.5 wt. %≤V≤2.5 wt. %, the rest being Fe and unavoidable impurities, or
35 wt. %≤Co≤55 wt. %, preferably 45 wt. %≤Co≤52 wt. %, 0 wt. %≤Ni≤0.5 wt. %, 0.5 wt. %≤V≤2.5 wt. %, the rest being Fe and unavoidable impurities, or
35 wt. %≤Co≤55 wt. %, 0 wt. %≤V≤2.5 wt. %, 0 wt. %≤(Ta+2Nb)≤1 wt. %, 0 wt. %≤Zr≤1.5 wt. %, 0 wt. %≤Ni≤5 wt. %, 0 wt. %≤C≤0.5 wt. %, 0 wt. %≤Cr≤1 wt. %, 0 wt. %≤Mn≤1 wt. %, 0 wt. %≤Si≤1 wt. %, 0 wt. %≤Al≤1 wt. %, 0 wt. %≤B≤0.01 wt. %, the rest being Fe and unavoidable impurities, or
5 to 25 wt. % Co, 0.3 to 5.0 wt. % V, 0 wt. %≤Si≤3 wt. %, 0 wt. %≤Cr≤3 wt. %, 0 wt. %≤Mn≤3 wt. %, 0 wt. %≤Al≤3 wt. %, the rest being Fe and unavoidable impurities, or
47 wt. %≤Co≤50 wt. %, 1 wt. %≤V≤3 wt. %, 0 wt. %≤Ni≤0.2 wt. %, 0.08 wt. %≤Nb≤0.12 wt. %, 0 wt. %≤C≤0.007 wt. %, 0 wt. %≤Mn≤0.5 wt. %, 0 wt. %≤Si≤0.1 wt. %, the rest being Fe and unavoidable impurities.
